(19) United States
(12) Patent Application Publication
(10) Pub. No.: US 2021/0263125 A1
(43) Pub. Date: Aug. 26, 2021

(54) WAVE-SOURCE-DIRECTION ESTIMATION DEVICE, WAVE-SOURCE-DIRECTION ESTIMATION METHOD, AND PROGRAM STORAGE MEDIUM

(71) Applicant: NEC Corporation, Minato-ku, Tokyo (JP)

(72) Inventors: Yumi ARAI, Tokyo (JP); Yuzo SENDA, Tokyo (JP); Reishi KONDO, Tokyo (JP)

(73) Assignee: NEC Corporation, Minato-ku, Tokyo (JP)

(21) Appl. No.: 17/252,391

(22) PCT Filed: Jun. 25, 2018
(86) PCT No.: PCT/JP2018/023970

§ 371 Date: Dec. 15, 2020

(51) Int. Cl. G01S 3/808; H04R 3/00; H04R 1/40; G10L 25/18

(52) U.S. Cl. CPC G01S 3/808; G10L 25/18; H04R 1/406; H04R 3/005

(57) ABSTRACT

A wave-source-direction estimation device includes: input units that acquire, as input signals, electrical signals that have been converted from waves acquired by sensors; a signal selection unit that selects at least two pairs that are each a combination of at least two input signals from among the input signals; a relative delay time calculation unit that calculates, as relative delay times, arrival time differences of the waves for each wave source searching direction between the at least two input signals composing one of the pairs of the input signals; at least one per-frequency estimated-direction-information generation unit that uses the pairs of the input signals and the relative delay times to generate estimated direction information on a wave source of the waves for each frequency; and an integration unit that integrates the estimated direction information generated for each frequency by the per-frequency estimated-direction-information generation unit.

### TECHNICAL FIELD

The present invention relates to a wave-source-direction estimation device, a wave-source-direction estimation method, and a program. In particular, the present invention relates to a wave-source-direction estimation device, a wave-source-direction estimation method, and a program that estimate a wave source direction based on signals acquired by a plurality of sensors.

### BACKGROUND ART

PTL 1 and NPL 1 disclose a method of estimating the direction of a sound source from the arrival time difference between sound receiving signals of two microphones. In the methods disclosed in PTL 1 and NPL 1, the sound source direction is estimated in such a way that the probability density function of the arrival time difference between sound waves is worked out for each frequency, and the arrival time difference is calculated from a probability density function obtained by superposing the probability density functions.

PTL 2 discloses a probe method of gathering sound and vibration transmitted to a predetermined observation point, and probing the sound source of a sound as to whether a sound has been generated from a vibration source. In the method disclosed in PTL 2, the sound transmitted from the sound source and the vibration of a surface wave transmitted from the vibration source are simultaneously measured. Then, the direction of the sound source obtained from the data of the sound pressure level of the sound and the direction of the vibration source obtained from the data of the vibration level of the vibration are compared, and it is determined whether the sound from the sound source is the sound from the vibration source that accompanies the generation of a sound.

### CITATION LIST

### Patent Literature

[PTL 1] WO 2018/003158 A
[PTL 2] JP 2010-236944 A

### Non Patent Literature

[NPL 1] M. Kato, Y. Senda, R. Kondo, “TDOA Estimation Based on Phase-Voting Cross Correlation and Circular Standard Deviation”, 25th European Signal Processing Conference (EUSIPCO), EURASIP, August 2017, pp. 1230-1234

### SUMMARY OF INVENTION

### Technical Problem

According to the methods of PTL 1 and NPL 1, in a frequency band where the signal-to-noise ratio (SNR) is high, the probability density function of the arrival time difference forms a sharp peak, such that the arrival time difference can be accurately estimated even when the high SNR band is small. However, in the methods of PTL 1 and NPL 1, when the probability density functions of arrival time differences of respective frequencies are superposed, a peak is generated in the superposed probability density functions because of the coincidental match between phases, even if no sound source exists. For this reason, the methods disclosed in PTL 1 and NPL 1 have a disadvantage in that a virtual-image sound source is erroneously estimated.

According to the method of PTL 2, it is possible to precisely determine whether the sound from the sound source is a sound from a vibration source that accompanies the generation of a sound or a sound from a sound source that does not accompany vibration, and to determine whether the vibration source is a vibration source that does not accompany sound. However, the method of PTL 2 has a disadvantage in that there is a possibility that the arrival time difference of the virtual-image sound source in a direction different from the sound source is calculated because of the coincidental match of phases between different microphones, and the virtual-image sound source is erroneously estimated.

It is an object of the present invention to provide a wave-source-direction estimation device capable of reducing erroneous estimation of a virtual-image sound source and highly accurately estimating the direction of a sound source by solving the above problems.

### Solution to Problem

A wave-source-direction estimation device according to one aspect of the present invention includes: a plurality of input units that acquire, as input signals, electrical signals that have been converted from waves acquired by a plurality of sensors; a signal selection unit that selects at least two pairs that are each a combination of at least two input signals from among a plurality of the input signals; a relative delay time calculation unit that calculates, as relative delay times, arrival time differences of the waves for each wave source searching direction between the at least two input signals composing one of the pairs of the input signals; at least one per-frequency estimated-direction-information generation unit that uses the pairs of the input signals and the relative delay times to generate estimated direction information on a wave source of the waves for each frequency; and an integration unit that integrates the estimated direction information generated for each frequency by the per-frequency estimated-direction-information generation unit.

A wave-source-direction estimation method according to one aspect of the present invention is implemented by an information processing device, and the wave-source-direction estimation method includes: acquiring, as input signals, electrical signals that have been converted from waves acquired by a plurality of sensors; selecting at least two pairs that are each a combination of at least two input signals from among a plurality of the input signals; calculating, as relative delay times, arrival time differences of the waves for each wave source searching direction between the at least two input signals composing one of the pairs of the input signals; using the pairs of the input signals and the relative delay times to generate at least one piece of estimated direction information on a wave source of the waves for each frequency; and integrating the estimated direction information generated for each frequency.

A program according to one aspect of the present invention causes a computer to execute: a process of acquiring, as input signals, electrical signals that have been converted from waves acquired by a plurality of sensors; a process of selecting at least two pairs that are each a combination of at least two input signals from among a plurality of the input signals; a process of calculating, as relative delay times, arrival time differences of the waves for each wave source searching direction between the at least two input signals composing one of the pairs of the input signals; a process of using the pairs of the input signals and the relative delay times to generate at least one piece of estimated direction information on a wave source of the waves for each frequency; and a process of integrating the estimated direction information generated for each frequency.

### Advantageous Effects of Invention

According to the present invention, it is possible to provide a wave-source-direction estimation device capable of reducing erroneous estimation of a virtual-image sound source and highly accurately estimating the direction of a sound source.

### BRIEF DESCRIPTION OF DRAWINGS

FIG. 1 is a block diagram illustrating an example of the configuration of a wave-source-direction estimation device according to a first example embodiment of the present invention.

FIG. 2 is a conceptual diagram for explaining an example of a process of a relative delay time calculation unit in the wave-source-direction estimation device according to the first example embodiment of the present invention.

FIG. 3 is a conceptual diagram for explaining another example of the process of the relative delay time calculation unit in the wave-source-direction estimation device according to the first example embodiment of the present invention.

FIG. 4 is a block diagram illustrating an example of the configuration of a per-frequency estimated-direction-information generation unit included in the wave-source-direction estimation device according to the first example embodiment of the present invention.

FIG. 5 is a block diagram illustrating an example of the configuration of a per-frequency cross-spectrum generation unit included in the wave-source-direction estimation device according to the first example embodiment of the present invention.

FIG. 6 is a block diagram illustrating an example of a configuration in which at least one sensor is added to the wave-source-direction estimation device according to the first example embodiment of the present invention.

FIG. 7 is a flowchart for explaining an outline of the operation of the wave-source-direction estimation device according to the first example embodiment of the present invention.

FIG. 8 is a flowchart for explaining the operation of the per-frequency estimated-direction-information generation unit of the wave-source-direction estimation device according to the first example embodiment of the present invention.

FIG. 9 is a flowchart for explaining the operation of the per-frequency cross-spectrum generation unit of the per-frequency estimated-direction-information generation unit of the wave-source-direction estimation device according to the first example embodiment of the present invention.

FIG. 10 is a block diagram illustrating an example of the configuration of a wave-source-direction estimation device according to a second example embodiment of the present invention.

FIG. 11 is a block diagram illustrating an example of a hardware configuration that achieves the wave-source-direction estimation device according to each example embodiment of the present invention.

### EXAMPLE EMBODIMENT

Modes for carrying out the present invention will be described below with reference to the accompanying drawings. However, while the example embodiments described below are limited to technologically preferred ones for carrying out the present invention, the scope of the invention is not limited to the following. In all the figures used in the following explanation of the example embodiments, the same reference signs are given to similar portions unless there is a particular reason. In the following example embodiments, a repetitive description of similar configuration and operation is omitted in some cases. The directions of the arrows in the drawings indicate examples and do not limit the directions of the signals between the blocks.

### First Example Embodiment

First, a wave-source-direction estimation device according to a first example embodiment of the present invention will be described with reference to the drawings. In the following, an example will be described in which the wave-source-direction estimation device of the present example embodiment estimates a generation source of a sound wave, which is a vibration wave of air or water. Therefore, the wave-source-direction estimation device of the present example embodiment verifies a vibration wave that has been converted into an electrical signal by a microphone. Note that the estimation target of the wave-source-direction estimation device of the present example embodiment is not limited to the generation source of the sound wave, but the wave-source-direction estimation device can be used to estimate the generation source (also referred to as wave source) of any wave such as a vibration wave or an electromagnetic wave.

(Configuration)

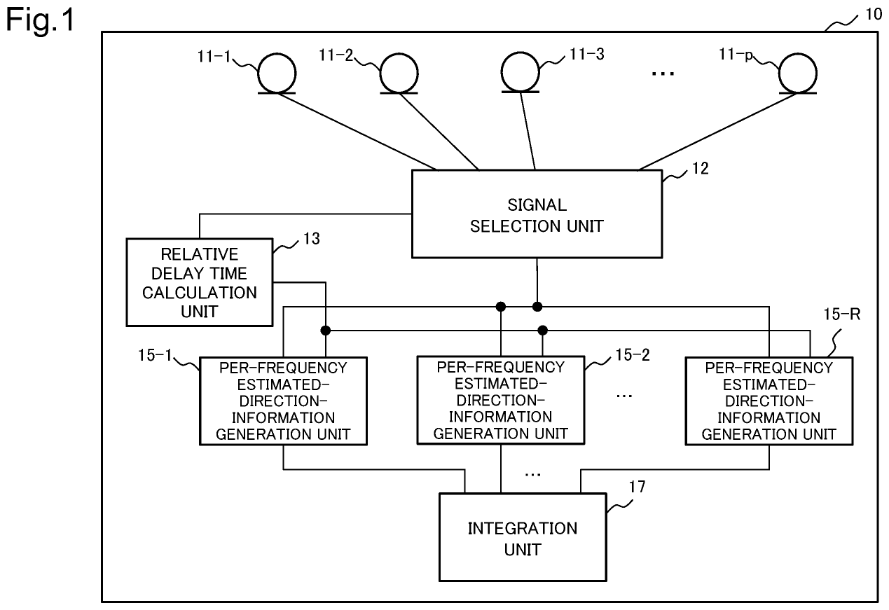

FIG. 1 is a block diagram representing the configuration of a wave-source-direction estimation device 10 of the present example embodiment. The wave-source-direction estimation device 10 includes input terminals 11, a signal selection unit 12, a relative delay time calculation unit 13, per-frequency estimated-direction-information generation units 15, and an integration unit 17.

The wave-source-direction estimation device 10 includes p input terminals 11 (p is an integer equal to or more than 2). The wave-source-direction estimation device 10 includes R per-frequency estimated-direction-information generation units 15 (R is an integer equal to or more than 1). In FIG. 1, in order to distinguish between the individual input terminals 11, numbers of 1 to p are each given to the end of the reference sign with a hyphen interposed therebetween. Similarly, in FIG. 1, in order to distinguish between the individual per-frequency estimated-direction-information generation units 15, numbers of 1 to R are each given to the end of the reference sign with a hyphen interposed therebetween.

[Input Terminal]

Each of the input terminals 11-1 to 11-p (also referred to as input units) is connected to a microphone (not illustrated) (hereinafter also referred to as mic). Electrical signals that have been converted from sound waves (also referred to as sound signals) collected by microphones arranged at different positions are input as input signals to each of the input terminals 11-1 to 11-p. In the following, the input signal input to the m-th input terminal 11-m at a time point t is denoted as xₘ(t) (t: a real number, m: an integer equal to or more than 1 but equal to or less than p).

The microphone is a sound collecting device that collects sound waves in which sounds generated by a desired sound source and various noises generated around the microphone are mixed, and converts the collected sound waves into digital signals (also referred to as sample value series). The microphones are arranged at different positions in one-to-one association with the input terminals 11-1 to 11-p in order to collect sounds from the desired sound source. In the following, it is assumed that an input signal that has been converted from a sound wave collected by an m-th microphone is supplied to the m-th input terminal 11-m. In the following, the input signal supplied to the m-th input terminal 11-m is also referred to as “m-th microphone input signal”.

[Signal Selection Unit]

The signal selection unit 12 selects two input signals from among P input signals supplied to the input terminals 11-1 to 11-p. The signal selection unit 12 outputs the two selected input signals to the per-frequency estimated-direction-information generation units 15-1 to 15-R, and outputs position information (hereinafter also referred to as microphone position information) on the microphones that are the supply sources of the input signals, to the relative delay time calculation unit 13. Here, the number R of the per-frequency estimated-direction-information generation unit 15 corresponds to the number R of combinations of input signals. The signal selection unit 12 may select all combinations or some combinations when selecting two input signals. When all combinations are selected, R is represented by following formula 1.

$$R = C ( p , 2 ) = \frac{p !}{2 ! ( p - 2 ) !} \qquad ( 1 )$$

The wave-source-direction estimation device 10 estimates the direction of a sound source, using the time difference produced when a sound from the desired sound source arrives at two microphones. If the interval between microphones (hereinafter also referred to as microphone interval) is too large, the direction estimation accuracy is lowered because the sound from the desired sound source is not observed as the single sound due to the influence of a medium such as air or water. If the microphone interval is too small, the direction estimation accuracy is also lowered because the arrival time difference of the sound waves between two microphones becomes too small. Therefore, the signal selection unit 12 preferably selects input signals of microphones of which microphone interval d falls within a fixed range as indicated by formula 2 (dₘᵢₙ, dₘₐₓ: real numbers).

dₘᵢₙ≤d≤dₘₐₓ (2)

For example, when the microphone interval d is sufficiently small, the signal selection unit 12 may select two input signals having the maximum microphone interval d. When the microphone interval d is sufficiently small, the signal selection unit 12 may sort the microphone intervals d in order from the larger microphone interval, and select a combination of input signals having larger microphone intervals up to the R-th place (r<C(p, 2)). In this manner, the signal selection unit 12 selects some combinations, which leads to a reduction in the calculation amount in addition to preventing the direction estimation accuracy from lowering.

The microphone position information is also important when working out the arrival time difference of the sound from the desired sound source to two microphones. Therefore, the signal selection unit 12 outputs the microphone position information to the relative delay time calculation unit 13 in addition to the input signals.

[Relative Delay Time Calculation Unit]

The microphone position information is input to the relative delay time calculation unit 13 from the signal selection unit 12. The relative delay time calculation unit 13 calculates relative delay time between the microphone pair for all the microphone pairs selected by the signal selection unit 12, using the microphone position information and a sound source search target direction. The relative delay time means the arrival time difference between sound waves uniquely defined based on the microphone interval and the sound source direction. For example, the sound source search target direction is set in increments of a predetermined angle. That is, the relative delay time is calculated by an amount equal to the number of sound source search target directions. The relative delay time calculation unit 13 outputs the calculated sound source search target direction and relative delay time as a set to the per-frequency estimated-direction-information generation unit 15.

The relative delay time is calculated using different methods depending on the positional relationship between the microphone pair. In the following, two positional relationships of the microphone pairs are demonstrated, and the calculation method for the relative delay time is indicated for each of these positional relationships of the microphone pairs.

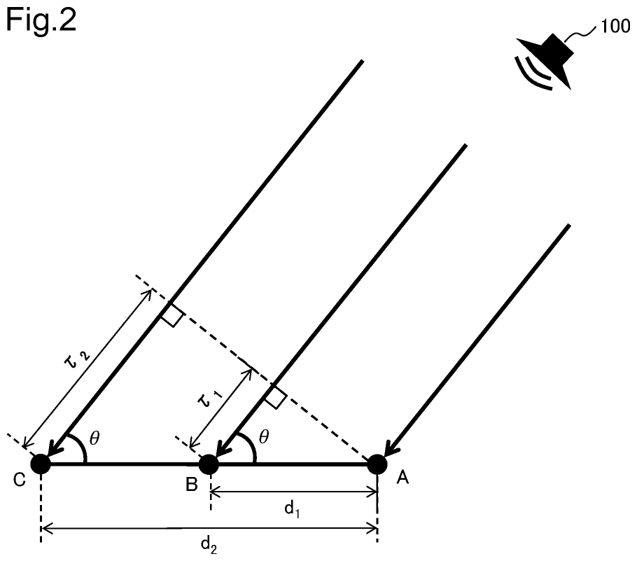

FIG. 2 is an example in which all microphones are arranged on the same straight line. In the example in FIG. 2, a case where there are three microphones will be described. Here, it is assumed that the sound velocity is c, the microphone interval is dᵣ, and the sound source search target direction (also referred to as sound source direction) is θ. The sound source direction θ is at least one angle set for estimating the direction of a sound source 100. At this time, a relative delay time τᵣ(0) with respect to the sound source direction θ can be calculated using following formula 3.

$${τ}_{r} ( θ ) = \frac{{d}_{r} cos θ}{c} \qquad ( 3 )$$

The microphone interval d differs depending on the combination of input signals selected by the signal selection unit 12. Therefore, the relative delay time τᵣ(0) is different for each combination number r. For example, assuming that the distance between a microphone pair AB in FIG. 2 is d₁, the relative delay time τ₁(0) can be calculated using following formula 4.

$${τ}_{1} ( θ ) = \frac{{d}_{1} cos θ}{c} \qquad ( 4 )$$

Assuming that the distance between a microphone pair AC in FIG. 2 is d₂, the relative delay time τ₂(θ) can be calculated using following formula 5.

$${τ}_{2} ( θ ) = \frac{{d}_{2} cos θ}{c} \qquad ( 5 )$$

As described above, when all microphones are positioned on the same straight line, the relative delay time τᵣ(0) in regard to a given sound source is proportional to the microphone interval d, but the sound source direction θ can be regarded as being the same as seen from any of the microphones.

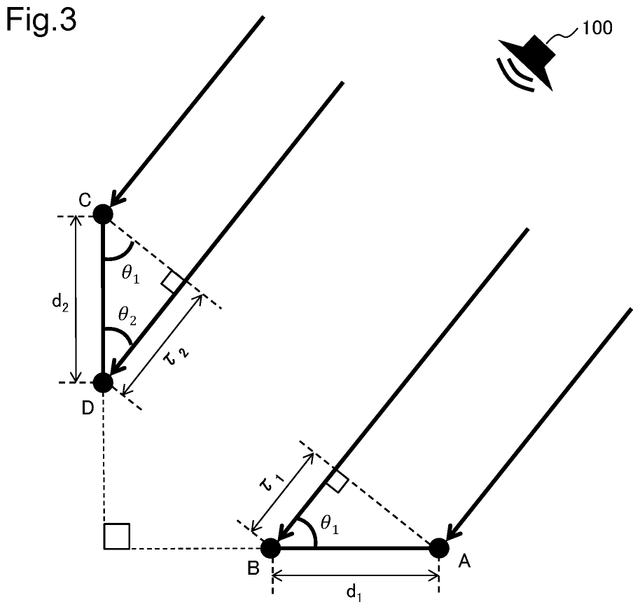

FIG. 3 is an example in which two microphone pairs are arranged on straight lines perpendicular to each other. In the example in FIG. 3, the sound source direction θ differs depending on the microphone pair. The relative delay time τ₁(0) between the microphone pair AB in FIG. 3 can be calculated using following formula 6.

$${τ}_{1} ( {θ}_{1} ) = \frac{{d}_{1} cos {θ}_{1}}{c} \qquad ( 6 )$$

Meanwhile, the relative delay time τ₂(θ) between microphones C and D in FIG. 3 can be calculated using following formula 7.

$${τ}_{2} ( {θ}_{1} ) = \frac{{d}_{2} cos {θ}_{2}}{c} = \frac{{d}_{2} cos ( 90 - {θ}_{1} )}{c} \qquad ( 7 )$$

In this manner, using a given microphone pair as a reference, the relative delay time τᵣ(0) of another microphone pair can be generalized as a function of the sound source direction θ as seen from the reference microphone pair, as indicated by following formula 8. Any microphone pair can be chosen as a reference microphone pair.

$${τ}_{r} ( θ ) = \frac{{d}_{r} cos {θ}_{r} ( θ )}{c} \qquad ( 8 )$$

The relative delay time calculation unit 13 calculates the relative delay time for all the sound source search target directions. For example, the relative delay time calculation unit 13 calculates 10 kinds of relative delay times when the sound source direction search range is from 0 to 90 degrees in increments of 10 degrees, in other words, 0 degrees, 10 degrees, 20 degrees, . . . , and 90 degrees. Then, the relative delay time calculation unit 13 outputs the sound source search target direction and the relative delay time to the per-frequency estimated-direction-information generation unit 15.

[Per-Frequency Estimated-Direction-Information Generation Unit]

Input signals of one microphone pair selected from among all microphone pairs by the signal selection unit 12 and the relative delay times supplied from the relative delay time calculation unit 13 are input to the per-frequency estimated-direction-information generation units 15-1 to 15-R. The per-frequency estimated-direction-information generation units 15-1 to 15-R generate per-frequency estimated direction information between the input signals of the one microphone pair, using the input signals of the microphone pair and the relative delay times that have been input.

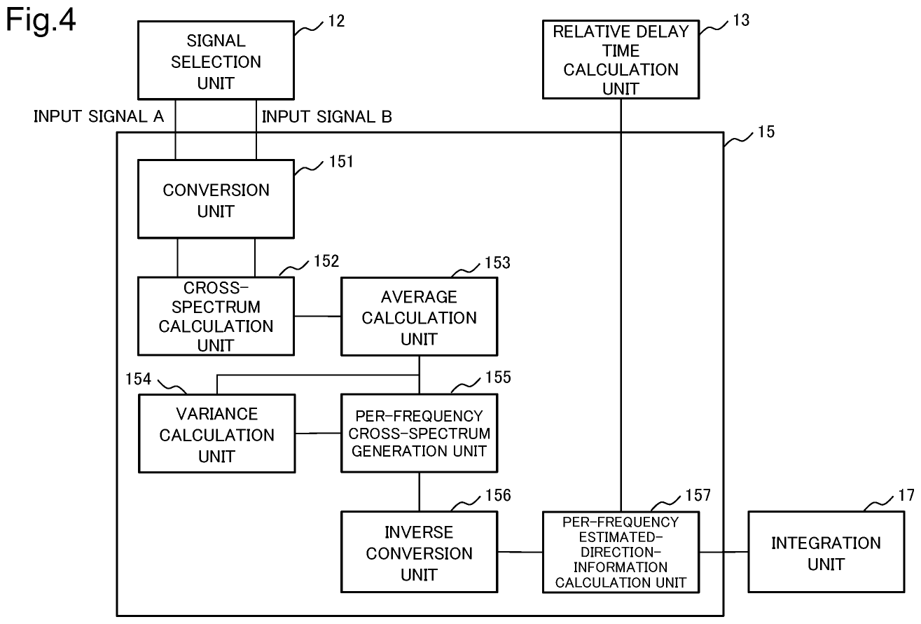

The detailed configuration of the per-frequency estimated-direction-information generation unit 15 will be described here with reference to FIG. 4. FIG. 4 is a block diagram of the per-frequency estimated-direction-information generation unit 15. The per-frequency estimated-direction-information generation unit 15 includes a conversion unit 151, a cross-spectrum calculation unit 152, an average calculation unit 153, a variance calculation unit 154, a per-frequency cross-spectrum generation unit 155, an inverse conversion unit 156, and a per-frequency estimated-direction-information calculation unit 157.

[Conversion Unit]

Two input signals (an input signal A and an input signal B) are input to the conversion unit 151 from the signal selection unit 12. The conversion unit 151 converts the two input signals supplied from the signal selection unit 12 into conversion signals (also referred to as frequency-domain signals). The conversion unit 151 performs conversion to decompose the input signals into a plurality of frequency components. For example, the conversion unit 151 decomposes the input signal into a plurality of frequency components using the Fourier transform. The conversion unit 151 outputs the conversion signals to the cross-spectrum calculation unit 152.

Two kinds of input signals xₘ(t) are input to the conversion unit 151. Here, m denotes the number given to the input terminal 11. The conversion unit 151 cuts out a waveform having an appropriate length from the input signal supplied from the input terminal 11 while shifting the waveform by a fixed period. The signal section thus cut out is referred to as frame, the length of the cut-out waveform is referred to as frame length, and the period by which the frame is shifted is referred to as frame period. Then, the conversion unit 151 converts the cut-out signal into a frequency-domain signal using the Fourier transform. Here, it is assumed that n is a frame number, and the input signal to be cut out is xₘ(t, n) (t=0, 1, . . . , K−1). At this time, the Fourier transform Xₘ(k, n) of the input signal xₘ(t, n) can be calculated using following formula 9.

$${X}_{m} ( k , n ) = {\sum }_{t = 0}^{K - 1} {x}_{m} ( t , n ) exp ( - j \frac{2 π tk}{K} ) \qquad ( 9 )$$

In above formula 9, j represents an imaginary unit, and exp represents an exponential function. Furthermore, k represents a frequency bin number and is an integer equal to or more than 0 but equal to or less than K−1. Hereinafter, for the sake of simplicity, k is simply referred to as frequency instead of the frequency bin number.

[Cross-Spectrum Calculation Unit]

The conversion signals are input to the cross-spectrum calculation unit 152 from the conversion unit 151. The cross-spectrum calculation unit 152 calculates a cross spectrum using the conversion signals supplied from the conversion unit 151. The cross-spectrum calculation unit 152 outputs the calculated cross spectrum to the average calculation unit 153.

The cross-spectrum calculation unit 152 calculates the product of the complex conjugate of the conversion signal X₂(k, n) and the conversion signal X₁(k, n) to calculate the cross spectrum. Here, the cross spectrum of the conversion signals is assumed to be S₁₂(k, n). At this time, the cross-spectrum calculation unit 152 calculates the cross spectrum using following formula 10.

S₁₂(k,n)=X₁(k,n)·conj(X₂(k,n)) (10)

Note that conj(X₂(k, n)) represents the complex conjugate of X₂(k, n). Alternatively, instead of formula 10, a cross spectrum normalized by an amplitude component may be used. The cross-spectrum calculation unit 152 calculates the cross spectrum using following formula 11 when performing normalization by an amplitude component.

$${S}_{12} ( k , n ) = \frac{{X}_{1} ( k , n ) \cdot conj ( {X}_{2} ( k , n ) )}{\vert {X}_{1} ( k , n ) \vert \vert {X}_{2} ( k , n ) \vert} \qquad ( 11 )$$

[Average Calculation Unit]

The cross spectrum is input to the average calculation unit 153 from the cross-spectrum calculation unit 152. The average calculation unit 153 calculates an average (also referred to as average cross spectrum) of the cross spectrum supplied from the cross-spectrum calculation unit 152. The average calculation unit 153 outputs the calculated average cross spectrum to the variance calculation unit 154 and the per-frequency cross-spectrum generation unit 155.

Here, an example will be described in which the average calculation unit 153 calculates the average cross spectrum for each frequency bin from the cross spectra input in the past. The average calculation unit 153 may calculate the average cross spectrum not in units of frequency bins but in units of subbands in which a plurality of frequency bins is bundled. Here, a cross spectrum at a frequency bin k of an n-th frame is assumed to be S₁₂(k, n). At this time, the average calculation unit 153 calculates an average cross spectrum SS₁₂(k, n) worked out from past L frames, using following formula 12.

$$S {S}_{12} ( k , n ) = \frac{1}{L} {\sum }_{m = 0}^{L - 1} {S}_{12} ( k , n - m ) \qquad ( 12 )$$

Alternatively, the average calculation unit 153 may calculate the average cross spectrum SS₁₂(k, n) using the following leak integration. In the formula, a denotes a real number more than 0 but less than 1.

SS₁₂(k,n)=(1−α)SS₁₂(k,n−1)+αS₁₂(k,n) (13)

[Variance Calculation Unit]

The average cross spectrum is input to the variance calculation unit 154 from the average calculation unit 153. The variance calculation unit 154 calculates variance using the average cross spectrum supplied from the average calculation unit 153. The variance calculation unit 154 outputs the calculated variance to the per-frequency cross-spectrum generation unit 155.

Here, the average cross spectrum is assumed to be SS₁₂(k, n). At this time, when the circular variance is used in the calculation of the phase variance of the cross spectrum, the variance calculation unit 154 calculates a variance V₁₂(k, n) using following formula 14.

V₁₂(k,n)=1−|SS₁₂(k,n)| (14)

The variance calculation unit 154 may calculate the variance V₁₂(k, n) using following formula 15.

V₁₂(k,n)=1−SS₁₂(k,n)² (15)

Alternatively, when the circular standard deviation is used, the variance calculation unit 154 calculates the variance V₁₂(k, n) using following formula 16.

V₁₂(k,n)=\sqrt{−2 ln|SS₁₂(k,n)|} (16)

[Per-Frequency Cross-Spectrum Generation Unit]

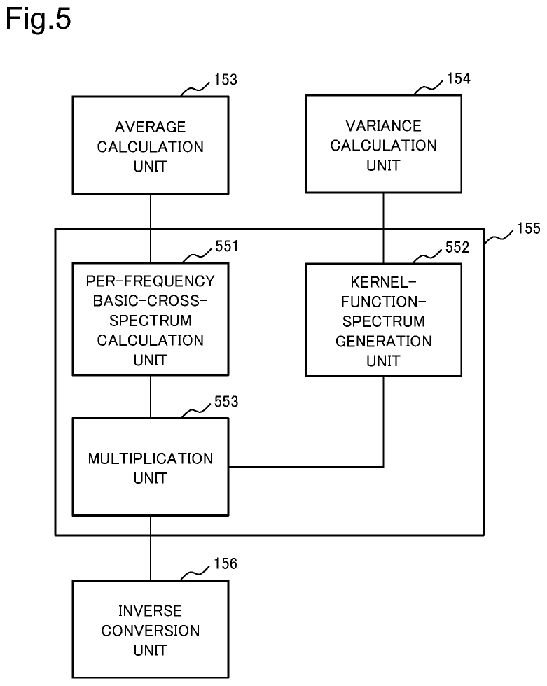

The configuration of the per-frequency cross-spectrum generation unit 155 will be described here with reference to the drawings. FIG. 5 is a block diagram illustrating an example of the configuration of the per-frequency cross-spectrum generation unit 155. As illustrated in FIG. 5, the per-frequency cross-spectrum generation unit 155 includes a per-frequency basic-cross-spectrum calculation unit 551, a kernel-function-spectrum generation unit 552, and a multiplication unit 553.

[Per-Frequency Basic-Cross-Spectrum Calculation Unit]

The average cross spectrum is input to the per-frequency basic-cross-spectrum calculation unit 551 from the average calculation unit 153. The per-frequency basic-cross-spectrum calculation unit 551 calculates a per-frequency basic cross spectrum using the average cross spectrum supplied from the average calculation unit 153. The per-frequency basic-cross-spectrum calculation unit 551 outputs the calculated per-frequency basic cross spectrum to the multiplication unit 553.

The per-frequency basic-cross-spectrum calculation unit 551 calculates a cross spectrum (also referred to as per-frequency basic cross spectrum) relevant to each frequency k of the average cross spectrum SS₁₂(k, n), using the average cross spectrum SS₁₂(k, n) supplied from the average calculation unit 153. The per-frequency basic-cross-spectrum calculation unit 551 outputs the calculated per-frequency basic cross spectrum to the multiplication unit 553. The per-frequency basic cross spectrum is calculated to calculate a correlation function for each frequency component. The per-frequency basic-cross-spectrum calculation unit 551 calculates a per-frequency basic cross spectrum for working out a correlation function (also referred to as per-frequency correlation function) relevant to a given frequency k in a subsequent stage.

Here, an example will be described in detail in which the per-frequency basic-cross-spectrum calculation unit 551 calculates the per-frequency basic cross spectrum of the frequency k. When calculating the per-frequency basic cross spectrum using the average cross spectrum SS₁₂(k, n) of the frequency k, the per-frequency basic-cross-spectrum calculation unit 551 works out a phase component and an amplitude component separately in advance, and then integrates the worked-out phase component and amplitude component. Assuming a per-frequency basic cross spectrum Uₖ(w, n) of the frequency k, its amplitude component as |Uₖ(w, n)|, and its phase component as arg(Uₖ(w, n)), the following relationship in formula 17 holds. In formula 17, w represents a frequency and is an integer equal to or more than 0 but equal to or less than W−1.

Uₖ(w,n)=|Uₖ(w,n)|exp(j·arg(Uₖ(w,n))) (17)

In the following, a method will be described in which the per-frequency basic-cross-spectrum calculation unit 551 works out the amplitude component |Uₖ(w, n)| and the phase component arg(Uₖ(w, n)) of the per-frequency basic cross spectrum, using the average cross spectrum SS₁₂(k, n) of the frequency k.

For the amplitude component |Uₖ(w, n)| of a frequency that is an integer multiple of k, 1.0 is used. On the other hand, the phase component of a frequency that is a non-integer multiple of k is set to zero. When the above is expressed as a mathematical formula, the amplitude component |Uₖ(w, n)| is given by following formula 18. In formula 18, p is an integer equal to or more than 1 but equal to or less than P.

$$\vert {U}_{k} ( w , n ) \vert = \{ \begin{matrix}1 , & if w = p \cdot k \\ 0 , & if w \neq p \cdot k\end{matrix} \qquad ( 18 )$$

Since the phase component is the important information when the wave source direction is estimated, an appropriate constant is used for the amplitude component as in formula 18. As the amplitude component |Uₖ(w, n)| of a frequency that is an integer multiple of k, |SS₁₂(k, n)| may be used instead of 1.0. In other words, the amplitude component |Uₖ(w, n)| may be worked out using following formula 19.

$$\vert {U}_{k} ( w , n ) \vert = \{ \begin{matrix}\vert {SS}_{12} ( k , n ) \vert , & if w = p \cdot k \\ 0 , & if w \neq p \cdot k\end{matrix} \qquad ( 19 )$$

For the phase component arg(Uₖ(w, n)) of a frequency obtained by multiplying k by an integer, a value obtained by multiplying the average cross spectrum SS₁₂(k, n) of the frequency k by a fixed value is used. For example, for the phase components of the frequencies k, 2 k, 3 k, and 4 k, a value obtained by multiplying each phase component arg(SS₁₂(k, n)) of the frequency k by an integer at the same magnification is used. That is, arg(SS₁₂(k, n)), 2 arg(SS₁₂(k, n)), 3 arg(SS₁₂(k, n)), and 4 arg(SS₁₂(k, n)) are used for the phase components of the frequencies k, 2 k, 3 k, and 4 k, respectively. On the other hand, the phase component of a frequency that is a non-integer multiple of k is set to zero. Accordingly, the phase component arg(Uₖ(w, n)) of the per-frequency basic cross spectrum relevant to the frequency k is calculated using following formula 20. In the formula, p is an integer equal to or more than 1 but equal to or less than P (P>1).

$$arg ( {U}_{k} ( w , n ) ) = \{ \begin{matrix}p \cdot arg ( {SS}_{12} ( k , n ) ) , & if w = p \cdot k \\ 0 , & if w \neq p \cdot k\end{matrix} \qquad ( 20 )$$

The per-frequency basic-cross-spectrum calculation unit 551 uses formula 17 to integrate the amplitude component calculated using formula 18 or 19 and the phase component calculated using formula 20, and obtains the per-frequency basic cross spectrum Uₖ(w, n) of the frequency k.

In the method described so far, the amplitude component and the phase component are separately worked out, and then the per-frequency basic cross spectrum is calculated. However, when the power of the cross spectrum indicated by following formula 21 is used, the per-frequency basic cross spectrum Uₖ(w, n) can be worked out without working out the amplitude component and the phase component.

$${U}_{k} ( w , n ) = \{ \begin{matrix}{{SS}_{12} ( k , n )}^{p} , & if w = p \cdot k \\ 0 , & if w \neq p \cdot k\end{matrix} \qquad ( 21 )$$

[Kernel-Function-Spectrum Generation Unit]

The variance is input to the kernel-function-spectrum generation unit 552 from the variance calculation unit 154. The kernel-function-spectrum generation unit 552 calculates a kernel function spectrum using the variance supplied from the variance calculation unit 154. The kernel function spectrum is obtained by taking the absolute value of the Fourier transform performed on the kernel function. For the kernel function spectrum, the Fourier transform performed on the kernel function may be squared, instead of taking the absolute value of the Fourier transform. The kernel function spectrum may be obtained by squaring the absolute value of the Fourier transform performed on the kernel function. The kernel-function-spectrum generation unit 552 outputs the calculated kernel function spectrum to the multiplication unit 553.

Here, it is assumed that the kernel function spectrum is G(w) and the kernel function is g(τ). The Gaussian function is used as the kernel function. At this time, the Gaussian function is given by following formula 22.

$$g ( τ ) = {g}_{1} exp ( - \frac{{( τ - {g}_{2} )}^{2}}{2 {g}_{3}^{2}} ) \qquad ( 22 )$$

In formula 22, g₁, g₂, and g₃ are positive real numbers. The size of the Gaussian function is controlled by g₁, the position of the peak of the Gaussian function is controlled by g₂, and the spread of the Gaussian function is controlled by g₃. In particular, g₃, which adjusts the spread of the Gaussian function, is important because g₃ greatly affects the sharpness of the peak of the per-frequency correlation function. That is, formula 22 indicates that the greater g₃ is, the larger the spread of the Gaussian function is.

The probability density function of a logistic distribution in following formula 23 may be used as the kernel function. In formula 23, g₄ and g₅ are positive real numbers.

$$g ( τ ) = \frac{exp ( - \frac{τ - {g}_{4}}{{g}_{5}} )}{{{g}_{5} ( 1 + exp ( - \frac{τ - {g}_{4}}{{g}_{5}} ) )}^{2}} \qquad ( 23 )$$

The probability density function of the logistic distribution has a shape similar to the shape of the Gaussian function, but has a longer tail than the Gaussian function. In particular, g₅, which adjusts the spread of the probability density function of the logistic distribution, is a parameter that greatly affects the sharpness of the peak of the per-frequency correlation function, as is the case of g₃ in the Gaussian function in formula 22. A cosine function or a uniform function may be used for the kernel function.

Among the parameters of the kernel function, g₃ and g₅, which affect the spread of the kernel function, are determined using the variance input from the variance calculation unit 154. Here, these parameters are referred to as spread control parameters and are expressed as q(k, n). Accordingly, when the kernel function is a Gaussian function, g₃ is q(k, n). If the variance is small, the parameter is changed in such a way that the peak of the per-frequency correlation function becomes sharper and the tail becomes narrower. Accordingly, the spread control parameter is made smaller.

The spread control parameter can be calculated by converting the value of the variance using a preset mapping function. For example, when the variance goes over a given threshold value, the spread control parameter is set to a large value (for example, 10), and when the variance falls below the given threshold value, the spread control parameter is set to a small value (for example, 0.01). Here, it is assumed that the variance is V₁₂(k, n), and the threshold value is pₜₕ. At this time, the spread control parameter q(k, n) at the frequency bin k of the n-th frame can be calculated using following formula 24. In formula 24, q₁ and q₂ are positive real numbers that satisfy q₁>q₂.

$$q ( k , n ) = \{ \begin{matrix}{q}_{1} , & {V}_{12} ( k , n ) \geq {p}_{th} \\ {q}_{2} , & {V}_{12} ( k , n ) < {p}_{th}\end{matrix} \qquad ( 24 )$$

The spread control parameter q(k, n) may be calculated using a linear function as in following formula 25. In formula 25, q₃ is a real number more than 0 and q₄ is a real number.

$$q ( k , n ) = \{ \begin{matrix}{q}_{3} {V}_{12} ( k , n ) + {q}_{4} , & {q}_{3} {V}_{12} ( k , n ) + {q}_{4} > 0 \\ 0 , & otherwise\end{matrix} \qquad ( 25 )$$

As q₃ and q₄, for example, values indicated by formulas and 27 may be used.

q₃=1/L (26)

q₄=0 (27)

L represents the number of frames averaged when the average calculation unit 153 works out the average cross spectrum. Since an error in the average cross spectrum is inversely proportional to the number of averaged frames L, the spread control parameter can be worked out by taking an error in the average cross spectrum (reliability) into consideration, by using formulas 26 and 27.

It is also possible to use a variance function represented by a linear mapping function, a high-order polynomial function, a nonlinear function, or the like to calculate the variance. The variance may be employed as the spread control parameter as it is.

The function that works out the spread control parameter may be constructed as a function for the frequency k as well as the variance. For example, a function that decreases as the frequency k increases can be used. Typical examples of such a function include an example using the inverse of k. In this case, instead of formula 25, the spread control parameter q(k, n) can be calculated using the function in following formula 28.

$$q ( k , n ) = \{ \begin{matrix}\frac{{q}_{1}}{k} , & {V}_{12} ( k , n ) \geq {p}_{th} \\ \frac{{q}_{2}}{k} , & {V}_{12} ( k , n ) < {p}_{th}\end{matrix} \qquad ( 28 )$$

Instead of formula 26, the spread control parameter q(k, n) can be calculated using the function in following formula 29.

$$q ( k , n ) = \{ \begin{matrix}\frac{{q}_{3} p ( k , n ) + {q}_{4}}{k} , & {q}_{3} p ( k , n ) + {q}_{4} > 0 \\ 0 , & otherwise\end{matrix} \qquad ( 29 )$$

[Multiplication Unit]

The per-frequency basic cross spectrum is input to the multiplication unit 553 from the per-frequency basic-cross-spectrum calculation unit 551, and the kernel function spectrum is input to the multiplication unit 553 from the kernel-function-spectrum generation unit 552. The multiplication unit 553 calculates the product of the per-frequency basic cross spectrum supplied from the per-frequency basic-cross-spectrum calculation unit 551 and the kernel function spectrum supplied from the kernel-function-spectrum generation unit 552 to calculate a per-frequency cross spectrum. The multiplication unit 553 outputs the calculated per-frequency cross spectrum to the inverse conversion unit 156.

Here, it is assumed that the per-frequency basic cross spectrum supplied from the per-frequency basic-cross-spectrum calculation unit 551 is Uₖ(w, n), and the kernel function spectrum supplied from the kernel-function-spectrum generation unit 552 is G(w). At this time, the multiplication unit 553 calculates a per-frequency cross spectrum UMₖ(w, n) using following formula 30.

UMₖ(w,n)=G(w)Uₖ(w,n) (30)

[Inverse Conversion Unit]

The per-frequency cross spectrum is input to the inverse conversion unit 156 from the multiplication unit 553 of the per-frequency cross-spectrum generation unit 155. For example, when the conversion unit 151 uses the Fourier transform, the inverse conversion unit 156 performs inverse conversion using the inverse Fourier transform. The inverse conversion unit 156 works out inverse conversion of the per-frequency cross spectrum supplied from the per-frequency cross-spectrum generation unit 155.

Here, the per-frequency cross spectrum supplied from the per-frequency cross-spectrum generation unit 155 is assumed to be UMₖ(w, n). At this time, the inverse conversion unit 156 inversely converts UMₖ(w, n) using following formula 31 to calculate a per-frequency cross-correlation function uₖ(τ, n).

$${u}_{k} ( τ , n ) = {\sum }_{w = 0}^{W - 1} {UM}_{k} ( w , n ) exp ( j \frac{2 πτ w}{W} ) \qquad ( 31 )$$

[Per-Frequency Estimated-Direction-Information Calculation Unit]

The per-frequency cross-correlation function is input to the per-frequency estimated-direction-information calculation unit 157 from the inverse conversion unit 156, and the relative delay time is input to the per-frequency estimated-direction-information calculation unit 157 from the relative delay time calculation unit 13. The per-frequency estimated-direction-information calculation unit 157 works out the correspondence relationship between the direction and the correlation value as per-frequency estimated direction information, using the per-frequency cross-correlation function supplied from the inverse conversion unit 156 and the relative delay times supplied from the relative delay time calculation unit 13. The per-frequency estimated-direction-information calculation unit 157 outputs the worked-out per-frequency estimated direction information to the integration unit 17.

Here, it is assumed that the per-frequency cross-correlation function is uₖ(τ, n), and the relative delay time is τᵣ(θ). At this time, the per-frequency estimated-direction-information calculation unit 157 calculates per-frequency estimated direction information H_{k, r}(θ, n) using following formula 32.

H_{k,r}(θ, n)=uₖ(τᵣ(θ),n) (32)

Using formula 32, since the correlation value is defined for each direction θ, it can be determined that there is a high possibility that the sound source is present in a direction in which the correlation value is high.

[Integration Unit]

The per-frequency estimated direction information is input to the integration unit 17 from the per-frequency estimated-direction-information generation units 15-1 to 15-R. The integration unit 17 integrates the per-frequency estimated direction information supplied from the per-frequency estimated-direction-information generation units 15-1 to 15-R to calculate integrated estimated direction information. The integration unit 17 works out one piece of estimated direction information by merging or superposing a plurality of pieces of per-frequency estimated direction information worked out individually. The integration unit 17 outputs the calculated integrated estimated direction information. For example, the integration unit 17 outputs the integrated estimated direction information to a higher-level system (not illustrated).

For example, the integration unit 17 first integrates pieces of the per-frequency estimated direction information H_{k, r}(θ, n) by an amount equal to the number of combinations (R combinations) of input signals, thereby calculating the per-frequency integrated estimated direction information Hₖ(θ, n). Then, the integration unit 17 integrates the calculated per-frequency integrated estimated direction information in terms of all frequencies, thereby calculating the integrated estimated direction information H(θ, n).

For example, the integration unit 17 calculates the per-frequency integrated estimated direction information Hₖ(θ, n) by calculating the sum of powers of the per-frequency estimated direction information H_{k, r}(θ, n). At this time, the integration unit 17 calculates the per-frequency integrated estimated direction information Hₖ(θ, n) using following formula 33.

$${H}_{k} ( θ , n ) = {H}_{k , 0} ( θ , n ) \cdot {H}_{k , 1} ( θ , n ) ⋯ {H}_{k , R - 1} ( θ , n ) = {\prod }_{r = 0}^{R - 1} {H}_{k , r} ( θ , n ) \qquad ( 33 )$$

Alternatively, for example, the integration unit 17 may calculate the per-frequency integrated estimated direction information Hₖ(θ, n) by calculating the sum of the per-frequency estimated direction information H_{k, r}(θ, n). At this time, the integration unit 17 calculates the per-frequency integrated estimated direction information Hₖ(θ, n) using following formula 34.

$${H}_{k} ( θ , n ) = {H}_{k , 0} ( θ , n ) \cdot {H}_{k , 1} ( θ , n ) ⋯ + {H}_{k , R - 1} ( θ , n ) = {\sum }_{r = 0}^{R - 1} {H}_{k , r} ( θ , n ) \qquad ( 34 )$$

In the calculation of the integrated estimated direction information H(θ, n), the integration unit 17 calculates the sum or the sum of powers of the per-frequency integrated estimated direction information Hₖ(θ, n) in terms of the frequency k.

For example, using following formula 35, the integration unit 17 calculates the sum of the per-frequency integrated estimated direction information Hₖ(θ, n) in terms of the frequency k, as the integrated estimated direction information H(θ, n).

$$H ( θ , n ) = {H}_{0} ( θ , n ) \cdot {H}_{1} ( θ , n ) ⋯ + {H}_{K - 1} ( θ , n ) = {\sum }_{k = 0}^{K - 1} {H}_{k} ( θ , n ) \qquad ( 35 )$$

Alternatively, for example, using following formula 36, the integration unit 17 calculates the sum of powers of the per-frequency integrated estimated direction information Hₖ(θ, n) in terms of the frequency k, as the integrated estimated direction information H(θ, n).

$$H ( θ , n ) = {H}_{0} ( θ , n ) \cdot {H}_{1} ( θ , n ) ⋯ {H}_{K - 1} ( θ , n ) = {\prod }_{k = 0}^{K - 1} {H}_{k} ( θ , n ) \qquad ( 36 )$$

When a frequency at which the desired sound is present or a frequency at which the power of the object sound is larger is known in advance, the integration unit 17 may work out the integrated estimated direction information using only the per-frequency integrated estimated direction information relevant to that frequency. The integration unit 17 may control the degree of influence of the per-frequency integrated estimated direction information in the integration in the form of weighting. For example, assuming that the set of frequencies where the desired sound is present is Ω, the integration unit 17 can work out the integrated estimated direction information H(θ, n) by selecting the frequency using following formula 37.

$$H ( θ , n ) = {\sum }_{k ∈ Ω} {H}_{k} ( θ , n ) \qquad ( 37 )$$

When the weighting is used, the integration unit 17 can calculate the integrated estimated direction information H(θ, n) using following formula 38. In formula 38, a and b are real numbers that satisfy a>b>0.

$$H ( θ , n ) = {\sum }_{k ∈ Ω} a \cdot {H}_{k} ( θ , n ) + {\sum }_{k ∉ Ω} b \cdot {H}_{k} ( θ , n ) \qquad ( 38 )$$

As described above, when the per-frequency integrated estimated direction information on the frequency at which the object sound is present is mainly used and integrated, a correlation function having a small influence of the non-object sound such as noise can be generated, and consequently the direction estimation accuracy is improved.

The integration unit 17 may use another calculation method to calculate the integrated estimated direction information H(θ, n). For example, the integration unit 17 first calculates per-input-signal-combination integrated estimated direction information Hᵣ(θ, n) in which the per-frequency estimated direction information H_{k, r}(θ, n) is integrated in terms of all frequencies. Then, the integration unit 17 may calculate the integrated estimated direction information H(θ, n) in which the per-input-signal-combination integrated estimated direction information is integrated in terms of all combinations of input signals.

The above is the description of the configuration of the wave-source-direction estimation device 10 of the present example embodiment.

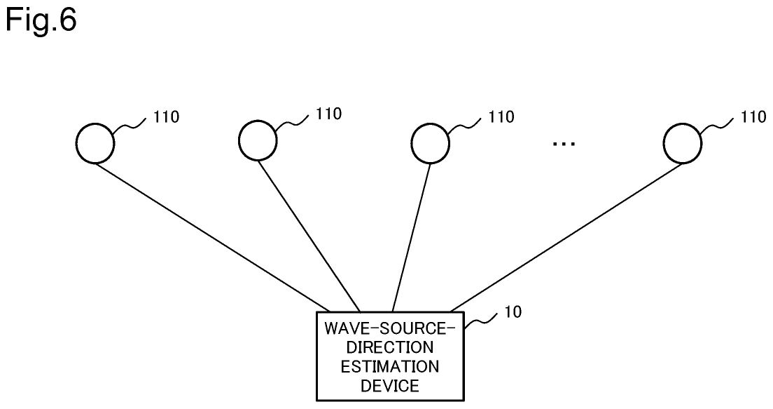

As illustrated in FIG. 6, a configuration in which at least one sensor 110 such as a microphone is added to the wave-source-direction estimation device 10 is also included in the scope of the present example embodiment. Each of the sensors 110 is connected to one of the input terminals 11 of the wave-source-direction estimation device 10 via a network or cable such as the Internet or an intranet.

For example, the sensor 110 is achieved by a microphone when detecting sound waves. For example, the sensor 110 is achieved by a vibration sensor when detecting vibration waves. For example, the sensor 110 is achieved by an antenna when detecting electromagnetic waves. As long as the sensor 110 can convert the target wave to be found into an electrical signal, no limitation is applied to the form of the sensor 110.

(Operation)

Next, the operation of the wave-source-direction estimation device 10 of the present example embodiment will be described with reference to the drawings.

[Wave Source Direction Estimation]

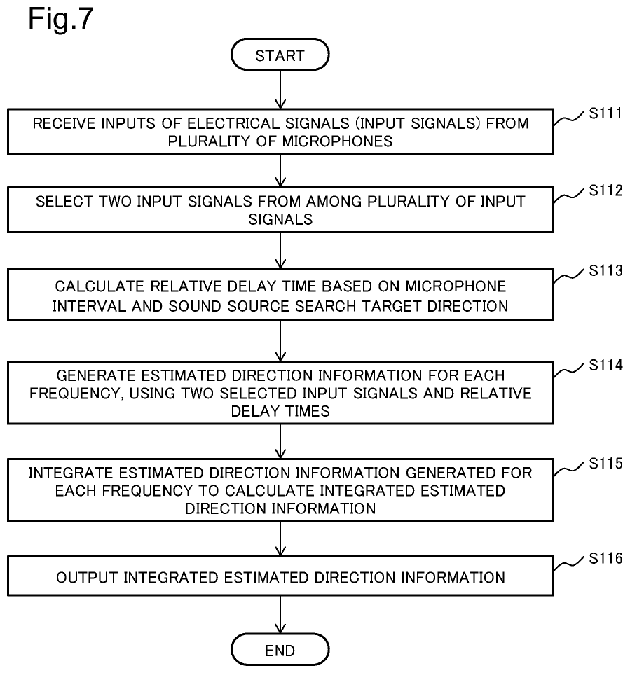

First, an outline of the operation of the wave-source-direction estimation device 10 will be described with reference to the flowchart in FIG. 7. In the description along the flowchart in FIG. 7, the wave-source-direction estimation device 10 will be described as the subject of the operation.

In FIG. 7, first, the wave-source-direction estimation device 10 receives inputs of electrical signals (also referred to as input signals) from a plurality of microphones (step S111).

Next, the wave-source-direction estimation device 10 selects two input signals from among the input signals relevant to the plurality of microphones (step S112).

Next, the wave-source-direction estimation device 10 calculates the relative delay time based on an interval (also referred to as microphone interval) between two microphones that are the supply sources of the two selected input signals, and the set sound source search target direction (step S113).

Next, the wave-source-direction estimation device 10 generates estimated direction information (also referred to as per-frequency estimated direction information) for each frequency, using the two selected input signals and the relative delay times (step S114).

Next, the wave-source-direction estimation device 10 integrates the estimated direction information generated for each frequency to calculate the integrated estimated direction information (step S115).

Then, the wave-source-direction estimation device 10 outputs the integrated estimated direction information (step S116).

The above is an outline of the operation of the wave-source-direction estimation device 10.

[Per-Frequency Estimated Direction Information Generation]

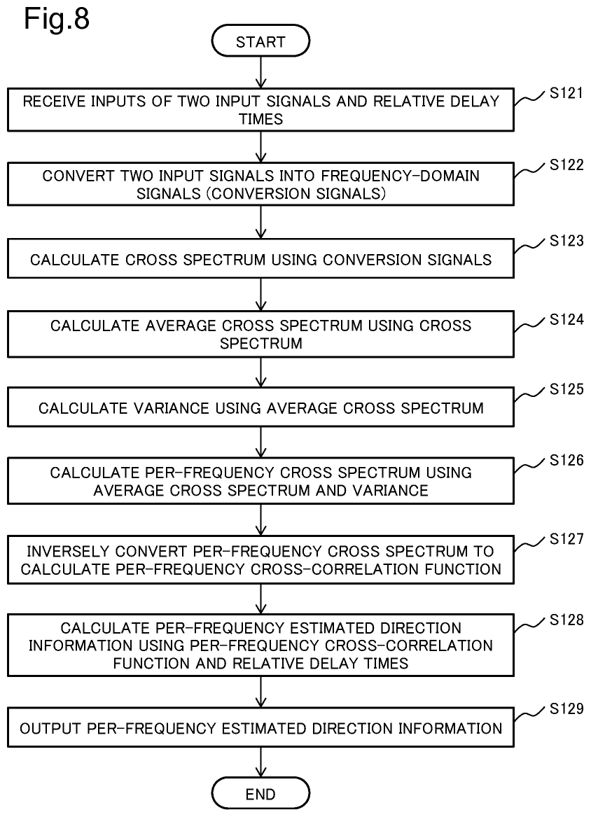

Next, the operation of the per-frequency estimated-direction-information generation unit 15 of the wave-source-direction estimation device 10 will be described with reference to the flowchart in FIG. 8. The process of the flowchart in FIG. 8 is a subdivision of step S114 of the flowchart in FIG. 7. In the description along the flowchart in FIG. 8, the per-frequency estimated-direction-information generation unit 15 is described as the subject of the operation.

In FIG. 8, first, the per-frequency estimated-direction-information generation unit 15 receives inputs of the two input signals selected by the signal selection unit 12 and the relative delay times of these input signals (step S121).

Next, the per-frequency estimated-direction-information generation unit 15 converts the two input signals into frequency-domain signals (also referred to as conversion signals) (step S122).

Next, the per-frequency estimated-direction-information generation unit 15 calculates the cross spectrum using the conversion signals (step S123).

Next, the per-frequency estimated-direction-information generation unit 15 calculates the average cross spectrum using the cross spectrum (step S124).

Next, the per-frequency estimated-direction-information generation unit 15 calculates the variance using the average cross spectrum (step S125).

Next, the per-frequency estimated-direction-information generation unit 15 calculates the per-frequency cross spectrum using the average cross spectrum and the variance (step S126).

Next, the per-frequency estimated-direction-information generation unit 15 calculates the per-frequency cross-correlation function using the per-frequency cross spectrum (step S127).

Next, the per-frequency estimated-direction-information generation unit 15 calculates the per-frequency estimated direction information using the per-frequency cross-correlation function and the relative delay times (step S128).

Then, the per-frequency estimated-direction-information generation unit 15 outputs the per-frequency estimated direction information to the integration unit 17 (step S129).

The above is the description of the operation of the per-frequency estimated-direction-information generation unit 15.

[Per-Frequency Cross Spectrum Generation]

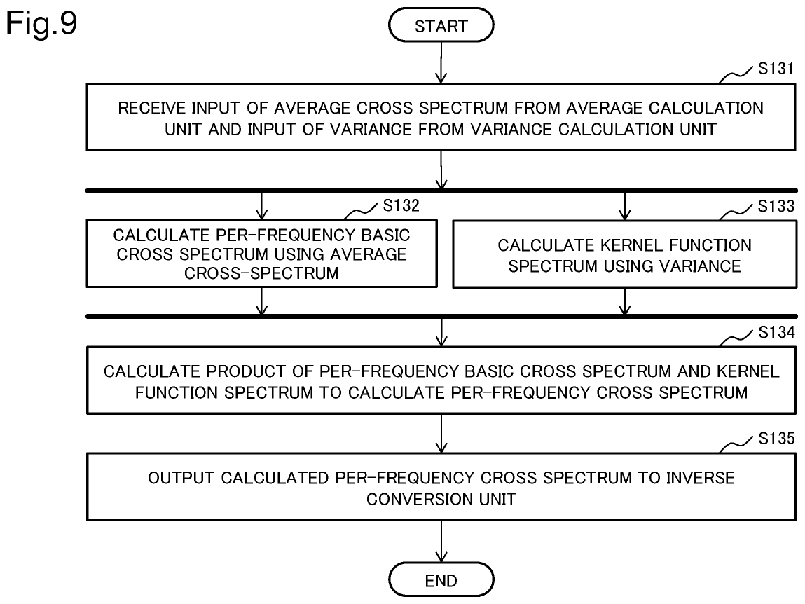

Next, the operation of the per-frequency cross-spectrum generation unit 155 included in the per-frequency estimated-direction-information generation unit 15 of the wave-source-direction estimation device 10 will be described with reference to the flowchart in FIG. 9. The process of the flowchart in FIG. 9 is a subdivision of step S125 of the flowchart in FIG. 8. In the description along the flowchart in FIG. 9, the per-frequency cross-spectrum generation unit 155 is described as the subject of the operation.

In FIG. 9, first, the per-frequency cross-spectrum generation unit 155 receives an input of the average cross spectrum from the average calculation unit 153, and an input of the variance from the variance calculation unit 154 (step S131).

Next, the per-frequency cross-spectrum generation unit 155 calculates the per-frequency basic cross spectrum using the average cross spectrum (step S132).

The per-frequency cross-spectrum generation unit 155 calculates the kernel function spectrum using the variance (step S133). The process in step S132 and the process in step S133 may be performed in parallel or sequentially.

Next, the per-frequency cross-spectrum generation unit 155 calculates the product of the per-frequency basic cross spectrum and the kernel function spectrum to calculate the per-frequency cross spectrum (step S134).

Then, the per-frequency cross-spectrum generation unit 155 outputs the calculated per-frequency cross spectrum to the inverse conversion unit 156 (step S135).

The above is the description of the operation of the per-frequency cross-spectrum generation unit 155.

As described above, the wave-source-direction estimation device of the present example embodiment includes a plurality of input units, a signal selection unit, a relative delay time calculation unit, at least one per-frequency estimated-direction-information generation unit, and an integration unit. The plurality of input units acquires, as input signals, electrical signals that have been converted from waves acquired by a plurality of sensors. The signal selection unit selects at least two pairs that are each a combination of at least two input signals from among a plurality of the input signals. The relative delay time calculation unit calculates, as relative delay times, arrival time differences of the waves for each wave source searching direction between the at least two input signals composing one of the pairs of the input signals. The at least one per-frequency estimated-direction-information generation unit uses the pairs of the input signals and the relative delay times to generate the estimated direction information on a wave source of the waves for each frequency. The integration unit integrates the estimated direction information generated for each frequency by the per-frequency estimated-direction-information generation unit.

For example, the signal selection unit selects a pair that is a combination of at least two input signals, based on an interval between the sensors, from among a plurality of the input signals.

For example, the relative delay time calculation unit calculate, as a reference function of the wave source searching direction, the relative delay times of all pairs of the input signals selected by the signal selection means with reference to the wave source searching direction for a pair of the sensors that are supply sources of one pair of the input signals.

For example, the per-frequency estimated-direction-information generation unit includes a conversion unit, a cross-spectrum calculation unit, an average calculation unit, a variance calculation unit, a per-frequency cross-spectrum generation unit, an inverse conversion unit, and an estimated-direction-information calculation unit. The conversion unit converts the at least two input signals forming one of the pairs into conversion signals in a frequency domain. The cross-spectrum calculation unit calculates a cross spectrum using the conversion signals that have been converted by the conversion means. The average calculation unit calculates an average cross spectrum using the cross spectrum calculated by the cross-spectrum calculation unit. The variance calculation unit calculates variance using the average cross spectrum calculated by the average calculation unit. The per-frequency cross-spectrum generation unit calculates a per-frequency cross spectrum using the average cross spectrum calculated by the average calculation unit and the variance calculated by the variance calculation unit. The inverse conversion unit inversely converts the per-frequency cross spectrum calculated by the per-frequency cross-spectrum generation unit to calculate a per-frequency cross-correlation function. The estimated-direction-information calculation unit calculates estimated direction information for each per-frequency estimated frequency using the per-frequency cross-correlation function calculated by the inverse conversion unit and the relative delay times.

For example, the per-frequency cross-spectrum generation unit includes a per-frequency basic-cross-spectrum calculation unit, a kernel-function-spectrum generation unit, and a multiplication unit. The per-frequency basic-cross-spectrum calculation unit acquires the average cross spectrum from the average calculation unit, and calculates a per-frequency basic cross spectrum using the acquired average cross spectrum. The kernel-function-spectrum generation unit acquires the variance from the variance calculation unit, and calculates a kernel function spectrum using the acquired variance. The multiplication unit calculates the product of the per-frequency basic cross spectrum calculated by the per-frequency basic-cross-spectrum calculation unit and the kernel function spectrum calculated by the kernel-function-spectrum generation unit to calculate a per-frequency cross spectrum.

For example, the integration unit calculates per-frequency integrated estimated direction information in which estimated direction information generated for each of a plurality of frequencies is integrated in terms of a plurality of pairs of the input signals. Then, the integration unit calculates the integrated estimated direction information by integrating the calculated per-frequency integrated estimated direction information in terms of all the frequencies.

For example, the integration unit calculates per-input-signal-combination integrated estimated direction information in which estimated direction information generated for each of a plurality of frequencies is integrated in terms of all frequencies. The integration unit calculates the integrated estimated direction information by integrating the calculated per-input-signal-combination integrated estimated direction information in terms of all combinations of the input signals.

For example, the wave-source-direction estimation device includes the sensors that are arranged in one-to-one association with a plurality of the input units.

The wave-source-direction estimation device of the present example embodiment works out the estimated direction information from the cross-correlation function between a microphone pair, and integrates the estimated direction information between a plurality of microphone pairs. As a result, according to the wave-source-direction estimation device of the present example embodiment, the false peak of the estimated direction information in a direction other than the sound source direction, which is generated due to the coincidental match of phases between the microphone pair, can be made smaller, the occurrence of erroneous estimation of a virtual-image sound source can be reduced, and the direction of the sound source can be highly accurately estimated.

The estimation target of the wave-source-direction estimation device of the present example embodiment is not limited to the generation source of the sound wave, which is the vibration wave in the air or water. The wave-source-direction estimation device of the present example embodiment can also be applied to the direction estimation for the generation source of a vibration wave of which the medium is a solid, such as an earthquake or a landslide. In this case, a vibration sensor can be used instead of a microphone for a device that converts vibration waves into electrical signals. Furthermore, the wave-source-direction estimation device of the present example embodiment can be applied not only to gas, liquid, and solid vibration waves but also to a case where the direction is estimated using radio waves. In the case of the direction estimation using radio waves, an antenna can be used as a device that converts radio waves into electrical signals.

The integrated estimated direction information estimated by the wave-source-direction estimation device of the present example embodiment can be used in various forms. For example, when the integrated estimated direction information has a plurality of peaks, it is estimated that a plurality of sound sources each having one of the peaks as the in-coming direction is present. Accordingly, by using the integrated estimated direction information, not only can the direction of each sound source be estimated simultaneously, but also the number of sound sources can be estimated.

### Second Example Embodiment

Next, a wave-source-direction estimation device according to a second example embodiment of the present invention will be described with reference to the drawings. The wave-source-direction estimation device of the present example embodiment has a configuration in which a wave-source-direction calculation unit is added to the wave-source-direction estimation device of the first example embodiment.

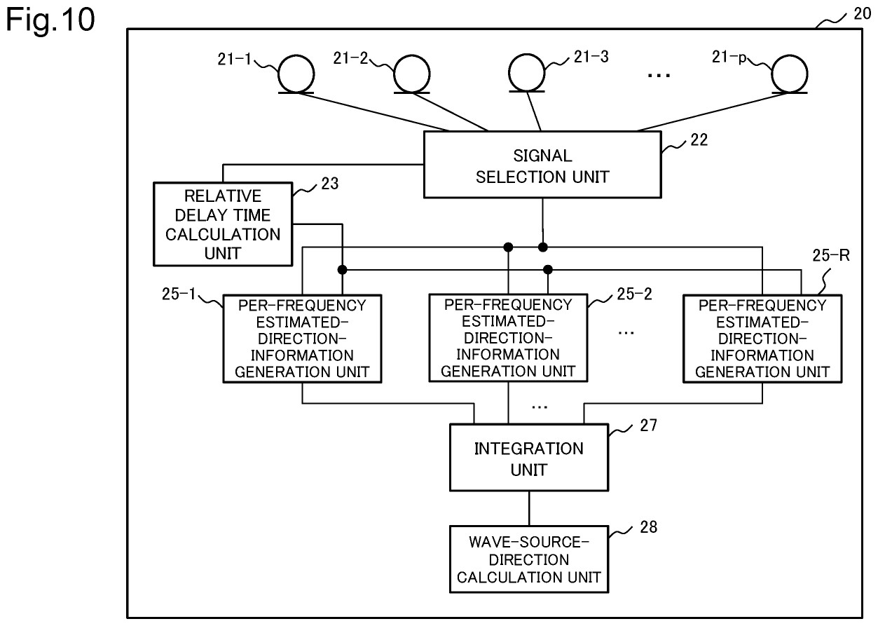

FIG. 10 is a block diagram representing the configuration of a wave-source-direction estimation device 20 of the present example embodiment. The wave-source-direction estimation device 20 includes input terminals 21, a signal selection unit 22, a relative delay time calculation unit 23, per-frequency estimated-direction-information generation units 25, an integration unit 27, and wave-source-direction calculation unit 28. Since the input terminals 21, the signal selection unit 22, the relative delay time calculation unit 23, the per-frequency estimated-direction-information generation units 25, and the integration unit 27 have configurations similar to the relevant configurations of the wave-source-direction estimation device 10 of the first example embodiment, a detailed description thereof will be omitted.

[Wave-Source-Direction Calculation Unit]

The integrated estimated direction information is input to the wave-source-direction calculation unit 28 from the integration unit 27. The wave-source-direction calculation unit 28 calculates the wave source direction using the integrated estimated direction information. The wave-source-direction calculation unit 28 outputs the calculated wave source direction.

The calculation method for the wave source direction in the wave-source-direction calculation unit 28 will be described in detail below. In the integrated estimated direction information input from the integration unit 27, the greater the peak, the higher the reliability (the possibility of the presence of a sound source). Therefore, for example, when it can be presumed beforehand that the number of sound sources is one, the wave-source-direction calculation unit 28 outputs a direction in which the integrated estimated direction information is maximum, as the estimated direction. Here, the integrated estimated direction information input from the integration unit 27 is assumed to be H(θ, n). The wave-source-direction calculation unit 28 can calculate, as a wave source direction θ, a set including, as an element, an argument of the integrated estimated direction information H(θ, n) supposed to allow the integrated estimated direction information H(θ, n) to take a maximum value, using following formula 39. In formula 39, θ represents all wave source directions or wave source direction candidates.

$$Θ = {argmax}_{θ} H ( θ , n ) \qquad ( 39 )$$

When the peak of the integrated estimated direction information exceeds a threshold value, the wave-source-direction calculation unit 28 can also regard a direction having the peak exceeding the threshold value as a sound source, and output the direction in which the threshold value is exceeded, as the estimated direction.

The wave-source-direction estimation device of the present example embodiment can also estimate, as the sound source direction, a direction relevant to a time point at which the integrated estimated direction information is maximum, at every fixed time T. However, it is presumed that the direction of the sound source does not change during the fixed time T or that the magnitude of the change is negligibly small. By presuming in this manner, the estimation accuracy for the wave source direction can be improved.

As described above, the wave-source-direction estimation device of the present example embodiment includes a wave-source-direction calculation means for calculating a wave source direction of the waves based on the integrated estimated direction information calculated by the integration means. For example, the wave-source-direction calculation means calculates, as the wave source direction, a direction relevant to a time point at which the integrated estimated direction information is maximum, at every fixed time. According to the wave-source-direction estimation device of the present example embodiment, the direction of the sound source can be highly accurately estimated without erroneous estimation of a virtual-image sound source.

(Hardware)

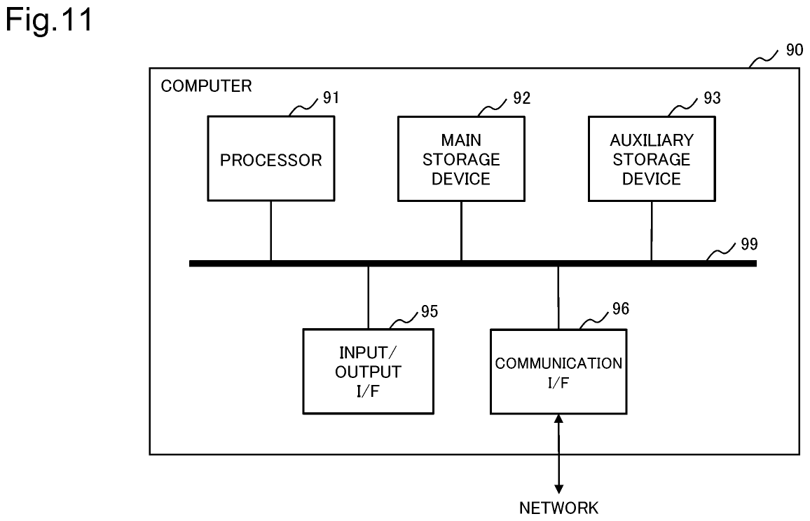

Here, the hardware configuration that executes the process of the wave-source-direction estimation device according to each example embodiment will be described with an information processing device 90 in FIG. 11 as an example. The information processing device 90 illustrated in FIG. 11 is an example of a configuration for executing the process of the wave-source-direction estimation device of each example embodiment, and does not limit the scope of the present invention.

As illustrated in FIG. 11, the information processing device 90 includes a processor 91, a main storage device 92, an auxiliary storage device 93, an input/output interface 95, and a communication interface 96. In FIG. 11, the interface is denoted as I/F as an abbreviation. The processor 91, the main storage device 92, the auxiliary storage device 93, the input/output interface 95, and the communication interface 96 are connected to each other via a bus 99 so as to enable data communication. The processor 91, the main storage device 92, the auxiliary storage device 93, and the input/output interface 95 are connected to a network such as the Internet or an intranet via the communication interface 96.

The processor 91 expands programs stored in the auxiliary storage device 93 and the like into the main storage device 92, and executes the expanded programs. The present example embodiment can employ a configuration using a software program installed in the information processing device 90. The processor 91 executes processes by the wave-source-direction estimation devices according to the present example embodiments.

The main storage device 92 has an area in which a program is expanded. The main storage device 92 can be, for example, a volatile memory such as a dynamic random access memory (DRAM). A nonvolatile memory such as a magnetoresistive random access memory (MRAM) may be configured and added as the main storage device 92.

The auxiliary storage device 93 stores diverse kinds of data. The auxiliary storage device 93 is constituted by a local disk such as a hard disk or a flash memory. A configuration for storing diverse kinds of data in the main storage device 92 can be employed such that the auxiliary storage device 93 is omitted.

The input/output interface 95 is an interface for connecting the information processing device 90 and peripheral equipment. The communication interface 96 is an interface for connecting to an external system or device through a network such as the Internet or an intranet in accordance with a standard or specifications. The input/output interface 95 and the communication interface 96 may be commonly used as an interface for connecting to external equipment.

The information processing device 90 may be configured such that input equipment such as a keyboard, a mouse, or a touch panel is connected to the information processing device 90 as required. These pieces of input equipment are used to input information and settings. When the touch panel is used as input equipment, a configuration for utilizing the display screen of display equipment also as an interface of the input equipment can be employed. Data communication between the processor 91 and the input equipment can be mediated by the input/output interface 95.

The information processing device 90 may be provided with display equipment for displaying information. When display equipment is provided, the information processing device 90 preferably includes a display control device (not illustrated) for controlling the display on the display equipment. The display equipment can be connected to the information processing device 90 via the input/output interface 95.

The information processing device 90 may be provided with a disk drive as required. The disk drive is connected to the bus 99. The disk drive mediates between the processor 91 and a storage medium (program storage medium) (not illustrated), such as reading data and program from the storage medium and writing the processing result of the information processing device 90 to the storage medium. The storage medium can be achieved by, for example, an optical storage medium such as a compact disc (CD) or a digital versatile disc (DVD). The storage medium may be achieved by a semiconductor storage medium such as a universal serial bus (USB) memory or a secure digital (SD) card, a magnetic storage medium such as a flexible disk, or another storage medium.

The above is an example of a hardware configuration for enabling the wave-source-direction estimation device according to each example embodiment. The hardware configuration in FIG. 11 is an example of a hardware configuration for executing the arithmetic process of the wave-source-direction estimation device according to each example embodiment, and does not limit the scope of the present invention. A program for causing a computer to execute a process relating to the wave-source-direction estimation device according to each example embodiment is also included in the scope of the present invention. Furthermore, a program storage medium on which a program according to each example embodiment is stored is also included in the scope of the present invention.

The constituent elements of the wave-source-direction estimation device of each example embodiment can be freely combined. The constituent elements of the wave-source-direction estimation device of each example embodiment may be achieved by software or by a circuit.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

Some or all of the above example embodiments can also be described as in the following supplementary notes, but are not limited to the following.

(Supplementary Note 1)

A wave-source-direction estimation device including:

a plurality of input means for acquiring, as input signals, electrical signals that have been converted from waves acquired by a plurality of sensors;

a signal selection means for selecting at least two pairs that are each a combination of at least two input signals from among a plurality of the input signals;

a relative delay time calculation means for calculating, as relative delay times, arrival time differences of the waves for each wave source searching direction between the at least two input signals composing one of the pairs of the input signals;

at least one per-frequency estimated-direction-information generation means for using the pairs of the input signals and the relative delay times to generate estimated direction information on a wave source of the waves for each frequency; and

an integration means for integrating the estimated direction information generated for each frequency by the per-frequency estimated-direction-information generation means.

(Supplementary Note 2)

The wave-source-direction estimation device according to supplementary note 1, in which the signal selection means

selects a pair that is a combination of at least two input signals, based on an interval between the sensors, from among the plurality of the input signals.

(Supplementary Note 3)

The wave-source-direction estimation device according to supplementary note 1 or 2, in which the relative delay time calculation means

calculates, as a reference function of the wave source searching direction, the relative delay times of all pairs of the input signals selected by the signal selection means with reference to the wave source searching direction for a pair of the sensors that are supply sources of one pair of the input signals.

(Supplementary Note 4)

The wave-source-direction estimation device according to any one of supplementary notes 1 to 3, in which the per-frequency estimated-direction-information generation means includes:

a conversion means for converting the at least two input signals forming one of the pairs into conversion signals in a frequency domain;

a cross-spectrum calculation means for calculating a cross spectrum using the conversion signals that have been converted by the conversion means;

an average calculation means for calculating an average cross spectrum using the cross spectrum calculated by the cross-spectrum calculation means;

a variance calculation means for calculating variance using the average cross spectrum calculated by the average calculation means;

a per-frequency cross-spectrum generation means for calculating a per-frequency cross spectrum using the average cross spectrum calculated by the average calculation means and the variance calculated by the variance calculation means;

an inverse conversion means for inversely converting the per-frequency cross spectrum calculated by the per-frequency cross-spectrum generation means to calculate a per-frequency cross-correlation function; and

a per-frequency estimated-direction-information calculation means for calculating the estimated direction information for each frequency using the per-frequency cross-correlation function calculated by the inverse conversion means and the relative delay times.

(Supplementary Note 5)

The wave-source-direction estimation device according to supplementary note 4, in which the per-frequency cross-spectrum generation means includes:

a per-frequency basic-cross-spectrum calculation means for acquiring the average cross spectrum from the average calculation means and calculating a per-frequency basic cross spectrum using the acquired average cross spectrum;

a kernel-function-spectrum generation means for acquiring the variance from the variance calculation means and calculating a kernel function spectrum using the acquired variance; and

a multiplication means for calculating a product of the per-frequency basic cross spectrum calculated by the per-frequency basic-cross-spectrum calculation means and the kernel function spectrum calculated by the kernel-function-spectrum generation means to calculate the per-frequency cross spectrum.

(Supplementary Note 6)

The wave-source-direction estimation device according to any one of supplementary notes 1 to 5, in which the integration means

calculates per-frequency integrated estimated direction information in which the estimated direction information generated for each of a plurality of frequencies is integrated in terms of a plurality of pairs of the input signals, and calculates integrated estimated direction information by integrating the calculated per-frequency integrated estimated direction information in terms of all the frequencies.

(Supplementary Note 7)

The wave-source-direction estimation device according to any one of supplementary notes 1 to 5, in which the integration means

calculates per-input-signal-combination integrated estimated direction information in which the estimated direction information generated for each of a plurality of frequencies is integrated in terms of all the frequencies, and calculates integrated estimated direction information by integrating the calculated per-input-signal-combination integrated estimated direction information in terms of all combinations of the input signals.

(Supplementary Note 8)

The wave-source-direction estimation device according to any one of supplementary notes 1 to 7, further including a wave-source-direction calculation means for calculating a wave source direction of the waves based on the integrated estimated direction information calculated by the integration means.

(Supplementary Note 9)

The wave-source-direction estimation device according to supplementary note 8, in which the wave-source-direction calculation means

calculates, as the wave source direction, a direction relevant to a time point at which the integrated estimated direction information is maximum, at every fixed time.

(Supplementary Note 10)

The wave-source-direction estimation device according to any one of supplementary notes 1 to 9, including the sensors that are arranged in one-to-one association with a plurality of the input means.

(Supplementary Note 11)

A wave-source-direction estimation method implemented by an information processing device, the wave-source-direction estimation method including:

acquiring, as input signals, electrical signals that have been converted from waves acquired by a plurality of sensors;

selecting at least two pairs that are each a combination of at least two input signals from among a plurality of the input signals;

calculating, as relative delay times, arrival time differences of the waves for each wave source searching direction between the at least two input signals composing one of the pairs of the input signals;

using the pairs of the input signals and the relative delay times to generate at least one piece of estimated direction information on a wave source of the waves for each frequency; and

integrating the estimated direction information generated for each frequency.

(Supplementary Note 12)

A program storage medium having stored therein a program for causing a computer to execute:

a process of acquiring, as input signals, electrical signals that have been converted from waves acquired by a plurality of sensors;

a process of selecting at least two pairs that are each a combination of at least two input signals from among a plurality of the input signals;

a process of calculating, as relative delay times, arrival time differences of the waves for each wave source searching direction between the at least two input signals composing one of the pairs of the input signals;

a process of using the pairs of the input signals and the relative delay times to generate at least one piece of estimated direction information on a wave source of the waves for each frequency; and

a process of integrating the estimated direction information generated for each frequency.

### REFERENCE SIGNS LIST

10, 20 wave-source-direction estimation device
11, 21 input terminal
12, 22 signal selection unit
13, 23 relative delay time calculation unit
15, 25 per-frequency estimated-direction-information generation unit
17, 27 integration unit
28 wave-source-direction calculation unit
151 conversion unit
152 cross-spectrum calculation unit
153 average calculation unit
154 variance calculation unit
155 per-frequency cross-spectrum generation unit
156 inverse conversion unit
157 per-frequency estimated-direction-information calculation unit
551 per-frequency basic-cross-spectrum calculation unit
552 kernel-function-spectrum generation unit
553 multiplication unit

What is claimed is:

1. A wave-source-direction estimation device comprising:
at least one memory storing instructions; and
at least one processor connected to the at least one memory and configured to execute the instructions to:
acquire, as input signals, electrical signals that have been converted from waves acquired by a plurality of sensors;
select at least two pairs that are each a combination of at least two input signals from among a plurality of the input signals;
calculate, as relative delay times, arrival time differences of the waves for each wave source searching direction between the at least two input signals composing one of the pairs of the input signals;
use the pairs of the input signals and the relative delay times to generate estimated direction information on a wave source of the waves for each frequency; and
integrate the estimated direction information generated for each frequency.

2. The wave-source-direction estimation device according to claim 1, wherein the at least one processor is configured to execute the instructions to
select a pair that is a combination of at least two input signals, based on an interval between the sensors, from among the plurality of the input signals.

3. The wave-source-direction estimation device according to claim 1, wherein, the at least one processor is configured to execute the instructions to
calculate, as a reference function of the wave source searching direction, the relative delay times of all pairs of the input signals selected with reference to the wave source searching direction for a pair of the sensors that are supply sources of one pair of the input signals.

4. The wave-source-direction estimation device according to claim 1, wherein the at least one processor is configured to execute the instructions to:
convert the at least two input signals forming one of the pairs into conversion signals in a frequency domain;
calculate a cross spectrum using the conversion signals that have been converted;
calculate an average cross spectrum using the cross spectrum;
calculate variance using the average cross spectrum;
calculate a per-frequency cross spectrum using the average cross spectrum and the variance;
inversely convert the per-frequency cross spectrum to calculate a per-frequency cross-correlation function; and
calculate the estimated direction information for each frequency using the per-frequency cross-correlation function.

5. The wave-source-direction estimation device according to claim 4, wherein the at least one processor is configured to execute the instructions to:
acquire the average cross spectrum;
calculate a per-frequency basic cross spectrum using the acquired average cross spectrum;
acquire the variance and calculate a kernel function spectrum using the acquired variance; and
calculate a product of the per-frequency basic cross spectrum and the kernel function spectrum to calculate the per-frequency cross spectrum.

6. The wave-source-direction estimation device according to claim 1, the at least one processor is configured to execute the instructions to
calculate per-frequency integrated estimated direction information in which the estimated direction information generated for each of a plurality of frequencies is integrated in terms of a plurality of pairs of the input signals, and
calculate integrated estimated direction information by integrating the calculated per-frequency integrated estimated direction information in terms of all the frequencies.

7. The wave-source-direction estimation device according to claim 1, wherein the at least one processor is configured to execute the instructions to
calculate per-input-signal-combination integrated estimated direction information in which the estimated direction information generated for each of a plurality of frequencies is integrated in terms of all the frequencies, and
calculate integrated estimated direction information by integrating the calculated per-input-signal-combination integrated estimated direction information in terms of all combinations of the input signals.

8. The wave-source-direction estimation device according to claim 7, wherein the at least one processor is configured to execute the instructions to
calculate a wave source direction of the waves based on the integrated estimated direction information.

9. The wave-source-direction estimation device according to claim 8, wherein the at least one processor is configured to execute the instructions to
calculate, as the wave source direction, a direction relevant to a time point at which the integrated estimated direction information is maximum, at every fixed time.

10. The wave-source-direction estimation device according to claim 1, comprising the sensors that are arranged in one-to-one association with a plurality of inputs.

11. A wave-source-direction estimation method implemented by an information processing device, the wave-source-direction estimation method comprising:
acquiring, as input signals, electrical signals that have been converted from waves acquired by a plurality of sensors;
selecting at least two pairs that are each a combination of at least two input signals from among a plurality of the input signals;
calculating, as relative delay times, arrival time differences of the waves for each wave source searching direction between the at least two input signals composing one of the pairs of the input signals;
using the pairs of the input signals and the relative delay times to generate at least one piece of estimated direction information on a wave source of the waves for each frequency; and
integrating the estimated direction information generated for each frequency.

12. A non-transitory program storage medium having stored therein a program for causing a computer to execute:
a process of acquiring, as input signals, electrical signals that have been converted from waves acquired by a plurality of sensors;
a process of selecting at least two pairs that are each a combination of at least two input signals from among a plurality of the input signals;
a process of calculating, as relative delay times, arrival time differences of the waves for each wave source searching direction between the at least two input signals composing one of the pairs of the input signals;
a process of using the pairs of the input signals and the relative delay times to generate at least one piece of estimated direction information on a wave source of the waves for each frequency; and
a process of integrating the estimated direction information generated for each frequency.
